(19) United States
(12) Patent Application Publication
(10) Pub. No.: US 2021/0253152 A1
(43) Pub. Date: Aug. 19, 2021

(54) INFORMATION PROCESSING DEVICE

(71) Applicant: TOSHIBA TEC KABUSHIKI KAISHA, Tokyo (JP)

(72) Inventors: Mika HIRAMA, Kokubunji Tokyo (JP); Yasuhiro KINOSHITA, Tama Tokyo (JP); Yu YOSHIIE, Yokohama Kanagawa (JP)

(21) Appl. No.: 17/172,016

(22) Filed: Feb. 9, 2021

(30) Foreign Application Priority Data
Feb. 17, 2020 (JP) 2020-024278

(51) Int. Cl. B62B 3/14; G06Q 30/06; G06F 3/0484; G06F 3/0488

(52) U.S. Cl. CPC B62B 3/1424; G06Q 30/0643; G06Q 30/0631; G06F 3/04886; G06F 3/04842; G06F 3/04883; B62B 3/1416

(57) ABSTRACT

An information processing device includes a camera configured to capture an image, a display including a touch panel and configured to display the image captured by the camera, a sensor configured to specify a position of the information processing device, and a processor. The processor being configured to, upon receipt of an input of a tap operation on the display of the captured image, calculating three-dimensional coordinates corresponding to an item in the captured image based on the position of the information processing device and the position of the tap operation on the captured image. The processor generating and outputting comment information including a comment received from a user of the information processing apparatus and the calculated three-dimensional coordinates.

### CROSS-REFERENCE TO RELATED APPLICATION

This application is based upon and claims the benefit of priority from Japanese Patent Application No. 2020-024278, filed on Feb. 17, 2020, the entire contents of which are incorporated herein by reference.

### FIELD

Embodiments described herein relate generally to information processing devices, information processing systems, and methods carried out by the information processing devices for receiving retail customer feedback.

### BACKGROUND

Some stores that sell merchandise have user terminals attached to shopping carts or the like. The terminals can be used for displaying advertisements, recommendations, or suggestions about merchandise for sale at the store or other information related to the store.

For such information to be displayed on the user terminal, the stores first need to prepare a digital poster, a digital leaflet, or the like, including the desired information and then register the poster, the leaflet, or the like on a content server that manages the digital data. However, such terminals generally fail to allow customers to give real-time feedback about the displayed information to the store or forward the information to another potential customer. Typically, feedback to the store must be made separately via a customer feedback questionnaire or via email or a social media rather via the user terminal.

### BRIEF DESCRIPTION OF THE DRAWINGS

FIG. 1 is a diagram schematically illustrating a store system according to an embodiment.

FIG. 2 is a block diagram illustrating a user terminal according to an embodiment.

FIG. 3 is a diagram illustrating a screen displayed on a user terminal according to an embodiment.

FIG. 4 is a diagram illustrating a screen displayed on a user terminal according to an embodiment.

FIG. 5 is a diagram illustrating a screen displayed on a user terminal according to an embodiment.

FIG. 6 is a flowchart of operations carried out by a user terminal according to an embodiment.

### DETAILED DESCRIPTION

One or more embodiments provide information processing devices that can receive shopper comments about store merchandise along with the particular store positions for the comment.

In general, according to one embodiment, an information processing device includes a camera configured to capture an image, a display including a touch panel and configured to display the image captured by the camera, a sensor configured to specify a position of the information processing device; and a processor. The processor is configured to, upon receipt of an input of a tap operation at a position on the display displaying the captured image, calculate three-dimensional coordinates corresponding to an item in the captured image based on the position of the information processing device and the position of the tap operation on the captured image. The processor being further configured to, upon receipt of an input of a comment after the tap operation has been input, generate and then output comment information including the comment and the calculated three-dimensional coordinates.

Hereinafter, certain example embodiments are described with reference to the drawings.

A store system according to an embodiment includes a user terminal attached to a cart that allows a user to make a comment relating to a merchandise item. The user terminal captures and displays an image of merchandise items displayed in the store. The user terminal displays the captured image as well as the user comment at the location in the store where the merchandise item is displayed. That is, the user terminal displays a user comment relating to a merchandise item superimposed or the like over an image of the item captured in the store. The store system thus enables the display of a user comment regarding an item of merchandise for sale in the store to be displayed in conjunction with the particular location (e.g., a display shelf or display area) of the item in the store.

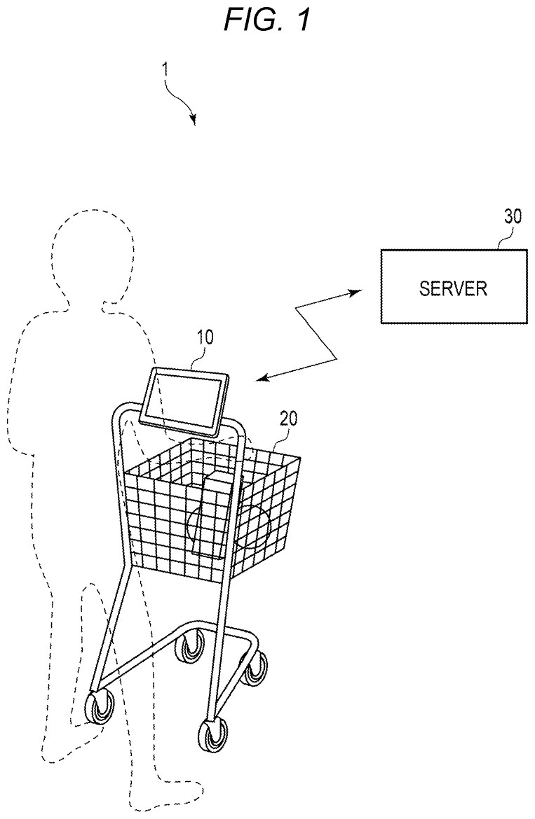

FIG. 1 illustrates a store system 1 according to an embodiment. As illustrated in FIG. 1, the store system 1 includes a user terminal 10, a cart 20, and a server 30. The server 30 is communicably connected to the user terminal 10.

The cart 20 is used by a user (a shopper) for conveying an article such as a merchandise item. The cart 20 has a frame and wheels to move and a basket attached to, or integrated into, the frame for holding a merchandise item placed by the user.

The cart 20 is provided with the user terminal 10.

The user terminal 10 is attached to the cart 20. For example, the user terminal 10 is attached to a position on the cart 20 so as to be viewable by the user while the user is using the cart 20. In the example illustrated in FIG. 1, the user terminal 10 is attached to the frame so as to face the user pushing the cart. The user terminal 10 is attached to the upper end of the cart 20.

The server 30 controls the entire operations of the store system 1. The server 30 transmits, to the user terminal 10, a comment (or other information) relating to a merchandise item and display information indicating a position within the store where the comment is to be displayed on the user terminal 10. The server 30 receives, from the user terminal 10, a comment that has been input by a user and comment information indicating the position within the store at which the user terminal 10 was used for the input of the user's comment.

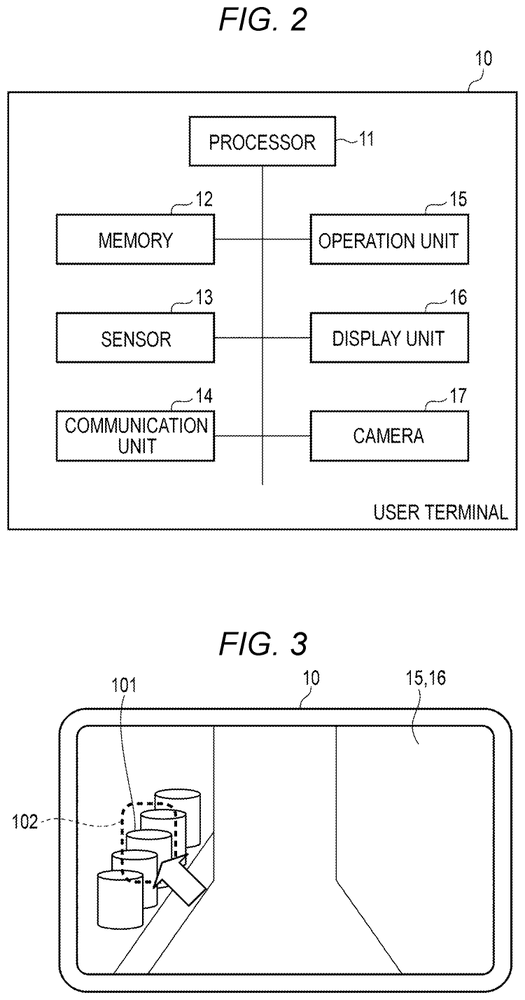

FIG. 2 is a block diagram illustrating the user terminal 10. As illustrated in FIG. 2, the user terminal 10 includes a processor 11, a memory 12, a sensor 13, a communication unit 14, an input operation unit 15, a display unit 16, a camera 17, and the like. The processor 11 is connected to the memory 12, the sensor 13, the communication unit 14, the input operation unit 15, the display unit 16, and the camera 17 via a data bus, an interface, or the like.

The user terminal 10 may further include additional devices, and one or more of the devices illustrated in FIG. 2 may be omitted.

The processor 11 controls the entire operations of the user terminal 10. For example, the processor 11 controls the display unit 16 to display an image captured by the camera 17. The processor 11 controls the display unit 16 to display a comment over the captured image in an overlapping manner.

For example, the processor 11 is a central processing unit (CPU) and the like. The processor 11 may be an application specific integrated circuit (ASIC) and the like. The processor 11 may be a field programmable gate array (FPGA) and the like.

The memory 12 stores various kinds of data. For example, the memory 12 includes a read only memory (ROM), a random access memory (RAM), and a non-volatile memory (NVM).

For example, the memory 12 stores one or more control programs for controlling basic operations of the user terminal 10, data required by the control programs, and the like. The control programs and data may be stored in the memory in advance.

The memory 12 temporarily stores data or the like during processes performed by the processor 11. The memory 12 may store data required for execution of one or more application programs, execution results of the application programs, or the like.

The sensor 13 is a sensor for specifying a position of the user terminal 10 in a store. The sensor 13 detects a position of the user terminal 10 or data for specifying the position. The sensor 13 outputs the position of the user terminal 10 or the detected data, which is acquired by the processor 11.

For example, the sensor 13 receives a positioning signal from an external transmitter installed in the store. The sensor 13 may be a gyro sensor, an acceleration sensor, and the like. Any other type of sensor may be used as the sensor 13.

The communication unit 14 is a network interface circuit configured to communicate with the server 30. For example, the communication unit 14 wirelessly communicates with the server 30. For example, the communication unit 14 supports wireless local area network (WLAN) protocols.

The input operation unit 15 is an input device configured to receive an input of various operations from the user. The input operation unit 15 outputs a signal indicating the input operation to the processor 11. Here, the input operation unit 15 is a touch panel or the like.

The display unit 16 displays various kinds of information according to signals from the processor 11. For example, the display unit 16 is a liquid crystal display (LCD). In one embodiment, the display unit 16 and the input operation unit 15 are integrated into a single touch-enabled display device.

The display unit 16 is attached to the cart 20 such that the user who pushes the cart 20 can view the displayed information. For example, the display unit 16 is installed so as to face the user of the cart 20.

The camera 17 captures images according to signals from the processor 11. The camera 17 supplies the captured image to the processor 11. For example, the camera 17 is a charge coupled device (CCD) image sensor or a complementary MOS (CMOS) image sensor.

The camera 17 faces forwards from the cart 20 and thus captures an image in the traveling direction of the cart 20. That is, the camera 17 faces in the traveling direction of the cart 20.

Various functions of the user terminal 10 are realized by the processor 11 executing a program stored in an internal memory, the memory 12, or the like.

The processor 11 performs a function of controlling the display unit 16 to display a captured image after the image is captured by the camera 17.

The processor 11 receives a capturing operation request from by the user via the input operation unit 15 or the like. Once the image capturing operation has been requested, the processor 11 starts to acquire an image with the camera 17 and then controls the display unit 16 to display the captured image. The processor 11 may repeatedly perform the image capture process and continuously display the most recently captured image so that the displayed image reflects the view of the user pushing the cart 20.

FIG. 3 illustrates a captured image displayed on the display unit 16. As illustrated in FIG. 3, a particular merchandise item 101 appears on the left side of the captured image.

The processor 11 has a function of receiving the input of a comment position via the operation unit 15.

The comment position is recorded as three-dimensional coordinates within a real space location, (for example, the store). The comment position are coordinates of a target object of a user comment. The user's comment about the target object can be displayed in an overlapped manner on an image of the target object.

To establish the coordinates for the comment position, the processor 11 controls sensor 13 to obtain the current position of the user terminal 10. That is, the processor 11 determines the three-dimensional coordinates at which the user terminal 10 is present in real space. Once this position is determined, if the processor 11 receives a user tap input operation unit 15 indicating the user wishes to input a comment the comment position can be determined or estimated.

After the tap operation on the input operation unit has been made, the processor 11 determines the two-dimensional coordinates on the displayed image on the display unit 16 corresponding to the position (hereinafter referred to as “tapped position”) where the tap operation has been made via the input operation unit 15. That is, while the processor 11 is causing the display unit 16 to display a view of the store where merchandise items, if a user tap input is received via the input operation unit 15 at location corresponding to a merchandise location, the processor 11 considers that a user comment is to be made at the tapped position.

Once the coordinates of the tapped position are determined, the processor 11 next determines whether the coordinates correspond to a position included in an area (hereinafter referred to as “commentable area”) where comments can be made. In general, the commentable area is any area other than the area (hereinafter referred to as “comment area”) where the comments are to be displayed on the display unit 16.

If the tapped position is in the commentable area, the processor 11 then determines a real position (that is, the three-dimensional coordinates in the real space which correspond to the tapped position) of the target item at the tapped position. The real position can be calculated or estimated based on the view angle of the camera 17, the position of the user terminal 10, the coordinates of the tapped position, and the like. That is, the processor 11 determines the three-dimensional coordinates for the target item in real space. The processor 11 sets this real space position as a comment position.

In the example illustrated in FIG. 3, if the user taps a position indicated by the arrow, then processor 11 determines the position where the merchandise item 101 is located (in the real space coordinates) as the comment position.

After the comment position is determined, the processor 11 obtains an image of the surrounding area of the tapped position. This image is referred to as a peripheral image or an image of peripheral area of the tapped position. The size of the peripheral image can be a predetermined size. For example, the peripheral image has a rectangular shape in this example.

In the example illustrated in FIG. 3, the processor 11 obtains an image of peripheral area 102 as the peripheral image.

The processor 11 has a function of accepting an input of a comment to be displayed at a comment position.

The comment relates particularly to a merchandise item (e.g., item 101) which is present at the comment position. For example, the comment is for the purpose of promotion of the merchandise item.

After the peripheral image is obtained, the processor 11 controls the display unit 16 to display a button or the like for receiving an input of a comment by the user.

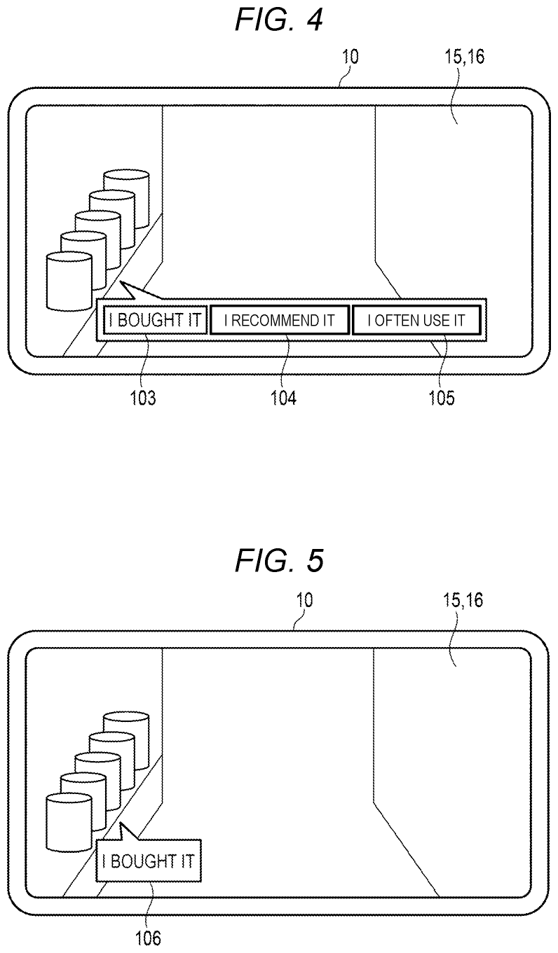

FIG. 4 illustrates an example of a screen for receiving the input of a comment. As illustrated in FIG. 4, buttons 103, 104, and 105 are displayed.

Each of the buttons 103 to 105 can receive an input to correspond to one of preset possible comments (e.g., “I bought it,” “I recommend it,” or “I often use it.”).

The processor 11 determines whether a tap operation has been made on one of the buttons 103 to 105.

In some examples, the input of a comment may be made by a user via a keyboard (for example, a physical keyboard or a screen keyboard). In some examples, the input of the comment may be made by voice input or otherwise.

In some examples, the comment may be received as the input of an icon such as an emoji or a distinguishing mark.

The input method and the content of the comment are not limited to the examples described above.

The processor 11 controls the communication unit 14 to transmit comment information including the user's comment, the comment position, and the like to the server 30.

The comment information generated by the processor 11 includes the comment, the comment position, and the peripheral image. After the comment information is generated, the processor 11 stores the comment information in the memory 12. After the comment information is stored, the processor 11 controls the communication unit 14 to transmit the comment information to the server 30.

The processor 11 also has a function of displaying a comment based on comment display information received from the server 30.

The comment display information includes a comment to be displayed and three-dimensional coordinates in the real space indicating where the comment is to be displayed. The processor 11 acquires the comment display information from the server 30 at startup (initialization) or continuously or the like.

The processor 11 controls the display unit 16 to display a comment on a captured image based on the received comment display information. For example, the processor 11 calculates the three-dimensional coordinates which correspond to various portions of a displayed image based on the angle of view of the camera 17 and the position of the user terminal 10. If the three-dimensional coordinates of each portion of a displayed image are calculated, the processor 11 can determine whether the three-dimensional coordinates indicated by the comment display information corresponds to (or are identical to) one of the calculated three-dimensional coordinates of portion of a displayed image.

If the three-dimensional coordinates indicated by the comment display information correspond to one of the portions of the displayed image, the processor 11 then specifies the two-dimensional coordinates on the display unit 16 which correspond to the three-dimensional coordinates of the matching portion. The processor 11 controls the display unit 16 to display the comment indicated by the comment display information at a position corresponding to the specified two-dimensional coordinates.

The processor 11 may control the display unit 16 to display a plurality of comments on the captured image based on multiple supplied instances of comment display information.

FIG. 5 indicates an example of a screen showing a comment. As illustrated in FIG. 5, the display unit 16 displays a comment area 106 on the captured image.

The comment area 106 displays the comment indicated by the comment display information. The comment area 106 is displayed at the display screen position corresponding to the three-dimensional coordinates indicated by the comment display information.

In the example of FIG. 5, the position indicated by the pointing portion of the comment area 106 corresponds to the three-dimensional coordinates indicated by the content display information.

In some examples, the processor 11 may control the display unit 16 to display the number of tap operations by other users on the comment. In such a case, the comment display information stores the number of tap operations. The processor 11 controls the display unit 16 to display the number of tap operations previously received on the comment area or the like.

The processor 11 has a function of detecting a tap operation on the comment area 106.

The processor 11 detects a tap operation made on the comment area 106 via the input operation unit 15. If the tap operation on the comment area 106 is detected, the processor 11 generates tap information indicating the tap on the comment displayed in the comment area 106.

The tap information may identify the comment display information corresponding to the comment. The tap information may include the three-dimensional coordinates which correspond to the tapped two-dimensional coordinates.

If the tap information is generated, the processor 11 stores the tap information in the memory 12. After the tap information is stored in the memory 12, the processor 11 controls the communication unit 14 to transmit the tap information to the server 30.

If the display information indicates the number of tap operations, the processor 11 may generate the tap information further indicating a value obtained by incrementing the number of tap operations indicated by the display information.

An operation example of the user terminal 10 is described.

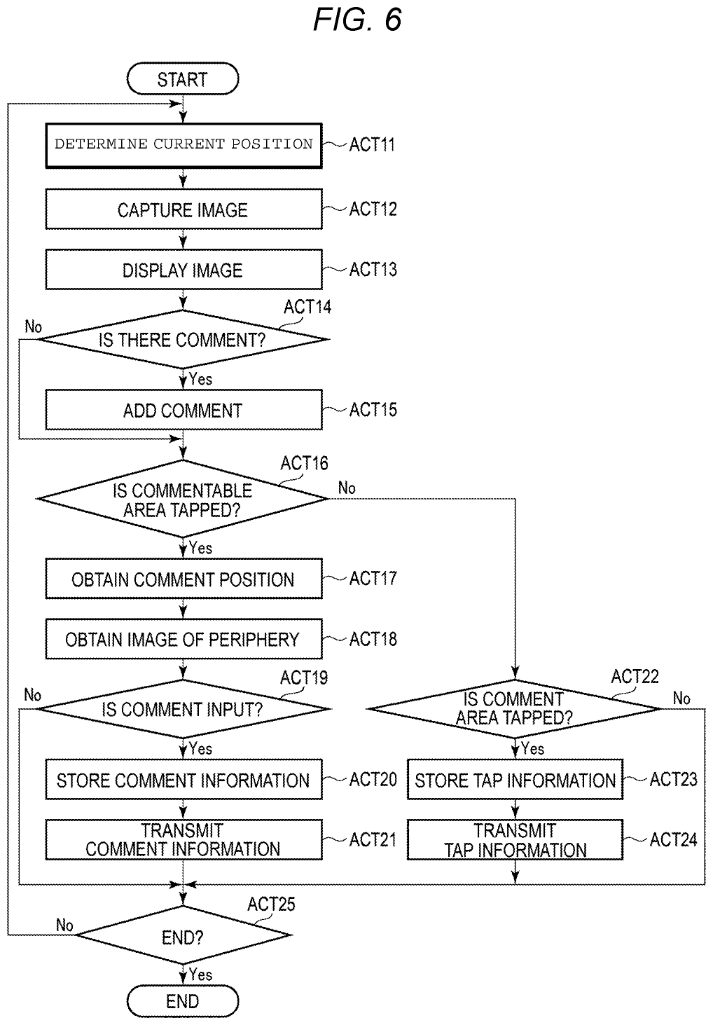

FIG. 6 is a flowchart of operations carried out by the user terminal 10.

First, the processor 11 of the user terminal 10 determines the current position of the user terminal 10 using the sensor 13 (Act 11). After the current position is determined, the processor 11 controls the camera 17 to capture an image (Act 12).

After the image is captured, the processor 11 controls the display unit 16 to display the captured image (Act 13). After the captured image is displayed on the display unit 16, the processor 11 determines whether there is a comment to be displayed based on comment display information from the server 30 (Act 14).

If it is determined that there is a comment to be displayed (Yes in Act 14), the processor 11 controls the display unit 16 to display a comment area including a comment (based on the previously received comment display information) on the displayed captured image in an overlapping manner (Act 15).

If it is determined that there is no comment to be displayed (No in Act 14), or if the comment area has already been displayed on the display unit 16 (in Act 15), the processor 11 next determines whether a tap operation has been made on the commentable area via the input operation unit 15 (Act 16).

If it is determined that a tap operation has been made on the commentable area (Yes in Act 16), the processor 11 determines the comment position based on the tapped position (Act 17). After the comment position is obtained, the processor 11 obtains a peripheral image from the captured image (Act 18).

After the peripheral image is obtained, the processor 11 determines whether a comment has been input (Act 19). If it is determined that the comment has been input (Yes in Act 19), the processor 11 stores comment information including the comment, the comment position, the peripheral image in the memory 12 (Act 20).

After the comment information is stored in the memory 12, the processor 11 controls the communication unit 14 to transmit the comment information to the server 30 (Act 21).

If it is determined that the comment has not been input (No in Act 19) (for example, if an input cancelling the input of the comment is received), or if the comment information has already been transmitted to the server 30 (Act 21), the processor 11 then determines whether to end the operation (Act 25).

In Act 16, if it is determined that the tap operation has not been input on the commentable area (No in Act 16), the processor 11 next determines whether a tap operation has been made on a comment area (Act 22).

If it is determined that the tap operation has been made on the comment area (Yes in Act 22), the processor 11 stores, in the memory 12, tap information indicating that the comment in the comment area has been tapped (Act 23). After the tap information is stored in the memory 12, the processor 11 controls the communication unit 14 to transmit the tap information to the server 30 (Act 24).

If it is determined that a tap operation has not been made in the comment area (No in Act 22), or if the tap information has been transmitted to the server 30 (Act 24), the processor 11 proceeds to Act 25.

If the operation is not yet to end (No in Act 25), the processor 11 returns to Act 11.

If the operation is to end (Yes in Act 25) (for example, if an operation for ending the operation has been input), the processor 11 ends the operation.

In some examples, the comment information need not include a peripheral image.

In some examples, the processor 11 may control the communication unit 14 to transmit the comment information and the tap information to the server 30 at predetermined intervals.

In some examples, the user terminal 10 may be a mobile terminal held, and carried, by the user rather than mounted on a cart 20 or otherwise.

The memory 12 may store the comment display information in advance rather than be supplied from the server 30 during operations. In such cases, the processor 11 obtains the comment display information that has been pre-stored in the memory 12.

The processor 11 may determine the current position of the user terminal 10 based on a captured image. For example, the processor 11 may read a code image, cue images, signs, or the like setup in the store or the like and determine the position based on these codes, cues, signs, or the like being visible in a captured image.

The user terminal 10 according to the aforementioned embodiments calculates three-dimensional coordinates in a real space (e.g., store) which correspond to the tapped position on the screen as the comment position. The user terminal 10 further accepts an input of a comment about a merchandise item displayed at the calculated coordinates. As a result, the user can use the user terminal 10 and timely and easily give feedback about the merchandise item sold in the store, and other users may review the feedback displayed on their terminals 10 while shopping in the same store.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a camera configured to capture an image;
a display including a touch panel and configured to display the image captured by the camera;
a sensor configured to specify a position of the information processing device; and
a processor configured to:
upon receipt of an input of a tap operation at a position on the display displaying the captured image, calculate three-dimensional coordinates corresponding to an item in the captured image based on the position of the information processing device and the position of the tap operation on the captured image, and
upon receipt of an input of a comment after the tap operation has been input, generate and output comment information including the comment and the calculated three-dimensional coordinates.

2. The information processing device according to claim 1, wherein the comment information includes a portion of the captured image surrounding the position of the tap operation.

3. The information processing device according to claim 1, wherein the processor is further configured to:
obtain comment display information including a comment to be displayed and three-dimensional coordinates corresponding to a position at which the comment to be displayed will be displayed, and
control the display to display the comment to be displayed on the captured image in an overlapping manner at a position in the captured image corresponding to the three-dimensional coordinates in the comment display information.

4. The information processing device according to claim 3, wherein
the comment display information further includes a total number of tap operations that have been made at the three-dimensional coordinates of the comment to be displayed, and
the processor is further configured to display the total number of tap operations on the captured image in conjunction with the comment to be displayed.

5. The information processing device according to claim 3, wherein the processor is further configured to, upon receipt of an input of a tap operation at the position in the captured image corresponding to the comment to be displayed, generate and output tap information indicating the position of the tap operation.

6. The information processing device according to claim 3, wherein the comment display information is received from an external device.

7. The information processing device according to claim 1, wherein the display is mounted on a shopping cart.

8. The information processing device according to claim 1, further comprising:
an interface circuit configured to communicate with an external device, wherein
the processor is further configured to control the interface circuit to transmit the comment information to the external device.

9. The information processing device according to claim 1, wherein the processor is further configured to, after the tap operation has been input, cause the display to display preset comments that can be selected via the touch panel.

10. The information processing device according to claim 9, wherein the preset comments are superimposed on the captured image.

11. An information processing system, comprising:
a server; and
an information processing device communicably connectable to the server, the information processing device including:
a camera configured to capture an image;
a display including a touch panel and configured to display the image captured by the camera;
a sensor configured to specify a position of the information processing device;
an interface circuit configured to communicate with the server; and
a processor configured to:
upon receipt of an input of a tap operation at a position on the display displaying the captured image, calculate three-dimensional coordinates corresponding to an item in the captured image based on the position of the information processing device and the position of the tap operation on the captured image,
upon receipt of an input of a comment after the tap operation has been input, generate comment information including the comment and the calculated three-dimensional coordinates, and
control the interface circuit to transmit the generated comment information to the server.

12. The system according to claim 11, wherein the comment information includes a portion of the captured image surrounding the position of the tap operation.

13. The system according to claim 11, wherein
the server is configured to provide comment display information including a comment to be displayed and three-dimensional coordinates corresponding to a position at which the comment to be displayed will be displayed, and
the processor is further configured to, upon receipt of the comment display information, control the display to display the comment to be displayed on the captured image in an overlapping manner at a position in the captured image corresponding to the three-dimensional coordinates in the comment display information.

14. The system according to claim 13, wherein
the comment display information further includes a total number of tap operations that have been made at the three-dimensional coordinates of the comment to be displayed, and
the processor is further configured to display the total number of tap operations on the captured image in conjunction with the comment to be displayed.

15. The system according to claim 13, wherein the processor is further configured to:
upon receipt of an input of a tap operation at the position in the captured image corresponding to the comment to be displayed, generate and output tap information indicating the position of the tap operation.

16. The system according to claim 13, wherein information processing apparatus is mounted on a shopping cart.

17. The system according to claim 11, wherein information processing apparatus is mounted on a shopping cart.

18. The system according to claim 11, wherein the processor is further configured to, after the tap operation has been input, cause the display to display preset comments that can be selected via the touch panel.

19. The system according to claim 11, wherein the sensor specifies the position based on a wireless positioning signal received by the sensor.

20. A method for receiving shopper comments at a retail store, the method comprising:
capturing an image with a camera mounted on a shopping cart being used by a shopper in a retail store;
displaying the captured image on a display mounted on the shopping cart;
specifying a position of the shopping cart in the retail store based on output from a position sensor;
upon receipt of an input of a tap operation at a position on the display displaying the captured image, calculating three-dimensional coordinates corresponding to an item in the captured image based on the position of the shopping cart and the position of the tap operation on the captured image;
upon receipt of an input of a comment after the tap operation has been input, generating comment information including the comment and the calculated three-dimensional coordinates; and
transmitting the generated comment information to a server.
